(19) United States
(12) Patent Application Publication
(10) Pub. No.: US 2013/0058744 A1
(43) Pub. Date: Mar. 7, 2013

(54) Bulk Material Handling System and Carrier Therefor

(71) Applicants: James E. Mothersbaugh, Muncy, PA (US); Steven S. Kelchner, Turbotville, PA (US); Joseph A. Hauser, Williamsport, PA (US)

(72) Inventors: James E. Mothersbaugh, Muncy, PA (US); Steven S. Kelchner, Turbotville, PA (US); Joseph A. Hauser, Williamsport, PA (US)

(21) Appl. No.: 13/224,391

(22) Filed: Sep. 2, 2011

(51) Int. Cl. B65G 65/32; B65D 88/66; B65D 88/22; B65D 33/02; B65D 33/36

(52) U.S. Cl. 414/303; 222/105

(57) ABSTRACT

A system including a receptacle having an inlet for receiving a poke material therethrough and a carrier for supporting a flexible bag with a closable discharge spout, containing a bulk material to be deposited in such receptacle, and means operable upon a bag loaded with bulk material being supported thereon such spout being aligned with such receptacle inlet and such spout being opening for jostling such bag to enhance the discharge of material through such spout into such receptacle, wherein such carrier and such receptacle are provided with cooperating configurations facilitating the positioning of such carrier relative to such receptacle with said bag spout aligned with such receptacle inlet.

This invention relates to a bulk material handling system and more particularly to such a system having means for enhancing the discharge of such a material from a container thereof into a bin or hopper. This invention further provides for a novel carrier for such a system including means for enhancing such discharge of material.

### BACKGROUND OF THE INVENTION

Bulk comminuted materials typically are deposited in bags formed of a flexible material which commonly are stored on pallets, transmitted by means fork lift trucks and/or overhead cranes and &posited in various bins or hoppers for blending, processing or other purposes. Generally, such bags include a peripheral wall, a closable top wall provided with a set of looped straps and a bottom wall including a spout which may be tied closed for storing and transportation purposes. In circumstances where the contents of such bags are to be fed into a bin or hopper for storage, blending, processing or other purposes, they arc suspended from a carrier by means of the looped straps thereof, connected to a hook of an overhead crane, transported by such crane to and positioned over an inlet of a selected bin or hopper and opened to permit the contents thereof to be gravity discharged into the selected bin or hopper.

Often, the material thus being transported and charged into a bin or hopper, has poor flow properties which impair or possibly prevent the free gravity discharge of such material from the bag. To contend with such occurrences, many of such bins or hoppers in which some materials are to be fed are provided with various means for jostling such bags positioned over such bins or hoppers to dislodge and impel the material and thus enhance its flowability in discharging such material from such bags. Such jostling means may consist of any form of device which impacts a bag being emptied to dislodge and propel the contents of the bag through the spout thereof.

In the use of such jostling devices for the purpose as described, it has been found that the provision of such. devices on each bin or hopper in which bags are to he emptied can be costly and often impractical or impossible to provide because of space limitations. Accordingly, the general object of the present invention is to provide an improved system for handling a bulk comminuted material utilizing flexible bags for holding and carrying a material to be transferred to a receptacle, and an improved carrier for use in such a system, which is more effective and economical in use.

### SUMMARY OF THE INVENTION

The principal object of the present invention is achieved by providing a system comprising a receptacle having an inlet for receiving a bulk material therethrough, and a carrier for supporting a flexible bag with a closable discharge spout containing a bulk material to be deposited in such receptacle, and means operable upon a bag loaded with bulk material being supported thereon, with the spout of the bag being aligned with such receptacle inlet and the spout thereof being open for jostling such bag to enhance the discharge of the material through such spout into the receptacle, wherein such carrier and such receptacle are provided with cooperating configurations facilitating the positioning of the lower end of such bag relative to such receptacle with the spout of such bag being aligned with the receptacle inlet. Such objective further is realized by the use of a carrier for a flexible bag containing a bulk comminuted material, having means for support on such carrier and a spout at a lower end thereof for discharging such material therefrom, generally comprising a frame having a lower open end and means cooperable with such support means of such bag for mounting said bag thereon with the tower end of said bag vertically aligned with the lower end of such frame, means disposed on such frame cooperable with a transporting means for displacing such frame and means mounted on such frame having means enagageable with a bag supported on such frame for selectively jostling such supported bag to enhance the flow and discharge of material within such bag through the spout thereof.

### BRIEF DESCRIPTION OF THE DRAWINGS

FIG. 1 is a perspective view of a carrier for supporting a flexible bag containing a bulk, comminuted material to be transported;

FIG. 2 is a view similar to the view shown in FIG. 1, having a bag consisting of a flexible material containing a bulk, comminuted material disposed within and suspended from such carrier;

FIG. 3 is a schematic of a system for operating certain devices mounted on the carrier shown in FIGS. 1 and 2 for jostling a bag suspended on a carrier as shown in FIG. 2;

FIG. 4 is a perspective view of the carrier having a bag of bulk, comminuted material suspended therefrom as shown in FIG. 2, positioned over a receptacle for the purpose of discharging the contents of the bag suspended on such carrier;

FIG. 5 is a diagrammatic view of a bag as shown in FIGS. 2 and 4 and the relative positions of the jostling devices of the carrier as shown in such views disposed in retracted, non-contacting positions; and

FIG. 6 is a view similar to the view shown in FIG. 5, illustrating the jostling devices in contact with a bag suspended from the carrier shown in FIGS. 2 and 4.

### DETAILED DESCRIPTION OF THE PREFERRED EMBODIMENTS OF THE INVENTION

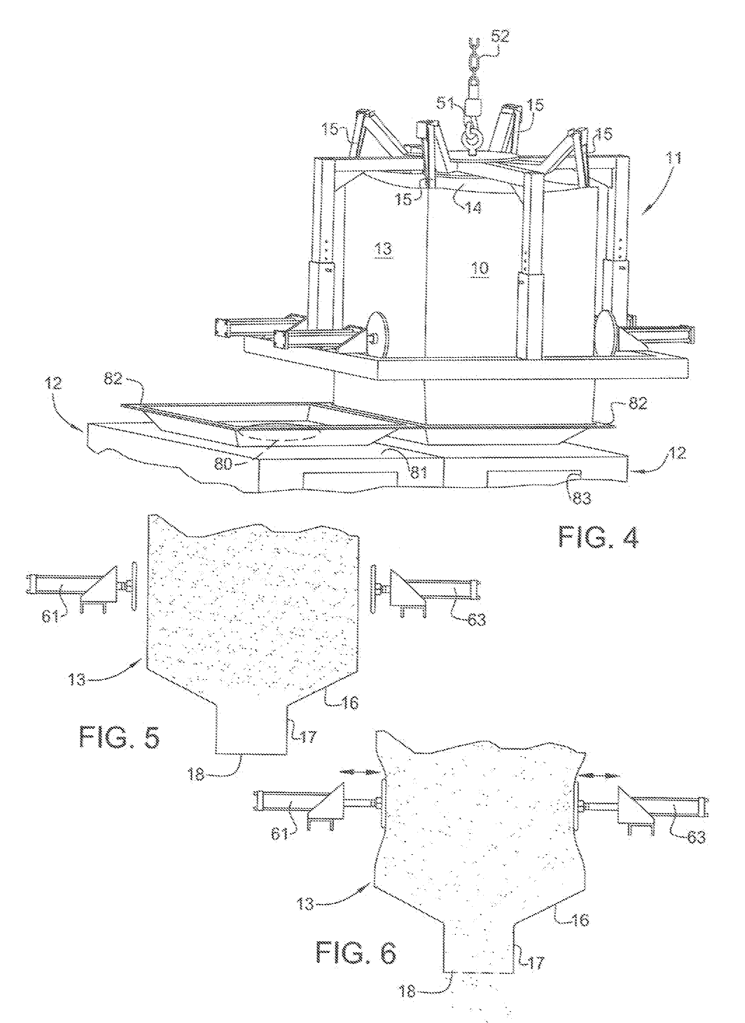

Referring to the drawings, there is illustrated a bulk material handling system for suspending, transporting and emptying a flexible bag 10 containing a comminuted material which includes a carrier 11 for supporting, transporting and positioning such bag over a receptacle 12 for the purpose of gravity discharging the material therefrom and further jostling the contents of such bag to enhance the discharge of such material into the receptacle. Referring to FIGS. 4 through 6; material holding bag 10 consists of a peripheral wall 13 disposable in an expanded condition within carrier 11, a top wall 14 provided with an opening (not shown) through which material to be transported may be introduced into the bag, which may be closed upon introducing such material, and a set of looped straps 15 which may be attached to the carrier for suspending the bag within the carrier, and a lower wall 16 which is sloped when the bag is filled with material toward a spout 17 having an opening 18, which spout may be collapsed, closed and tied to lower wall 16 for retaining material within the bag during storage and transportation of the material.

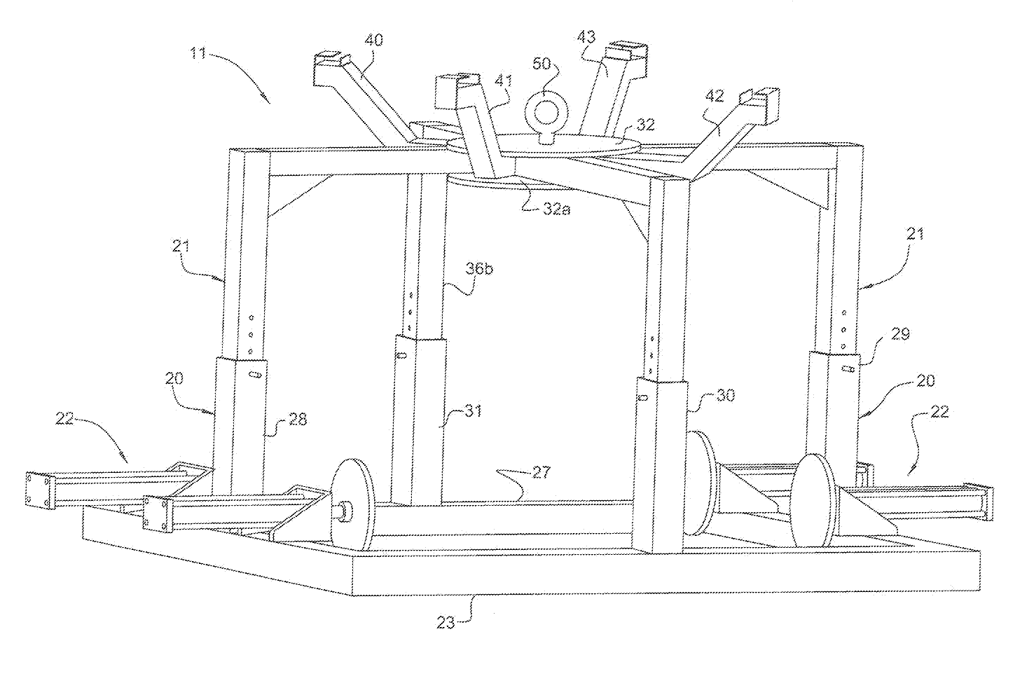

Referring to FIGS. 1 through 3, carrier 11 consists of a lower assembly 20 and upper assembly 21 cooperable with lower assembly 20, and sets of assemblies 22,22 mounted on lower assembly 20 operable for jostling a bag 10 disposed within and suspended from the carrier. Lower carrier assembly 20 includes a peripheral section 23 including a pair of laterally spaced segments 24 and 25 interconnected at their ends by a pair of transversely disposed segments 26 and 27, and a set of upwardly extending segments 28 and 29 disposed at the midsections of segments 24 and 25 and a set of upstanding segments 30 and 31 disposed at the midsections of segments 26 and 27. Upper section 21 consists of a pair of plate members 32 and 32a disposed at a vertical centerline of the carrier and in planes perpendicular to such centerline, and a set of circumferentially spaced, radially disposed dog-leg members 33 through 36. Member 33 includes a radially disposed segment 33a and a depending segment 33b telescopically connected to segment 28, member 34 includes a radially disposed segment 34a and a depending segment 34b which is telescopically connected to segment 30, member 35 includes a radially disposed segment 35a and a depending segment 35b telescopically connected to segment 29 and member 36 includes a radially disposed segment 36a and a depending segment 36b which is telescopically connected to segment 31. Each of such depending segments is provided with a vertically spaced set of pin receiving openings each adapted to register with a comparable opening in one of segments 28 through 31 to receive a pin 37 for fixing the displacement of upper assembly 21 relative to lower assembly 20.

Radial segments 33a through 36a are rigidly connected to plate members 32 and 32a. Also rigidly secured to the underside of plate number 32a, disposed between sets of dog-leg members and extending radially is a set of hanger arms 40 through 43. Each of such hanger arms includes a radially disposed segment and a segment extending upwardly at an angle from such radial segment, provided with a laterally extending portion on which a looped strap 15 may be hooked to support bag 13 within the carrier with upper wall 14 thereof disposed immediately below the radially disposed segments of the dog-leg members and the peripheral wall 13 disposed within the depending segments of the dog-leg members with the lower end thereof extending below frame member 23. Plate member 32 further is provided with an attachment 50 positioned on the centerline of the carrier having an eyelet adapted to receive a hook 51 of an overhead crane line 52 as shown in FIG. 4 for lifting, lowering and transporting the carrier.

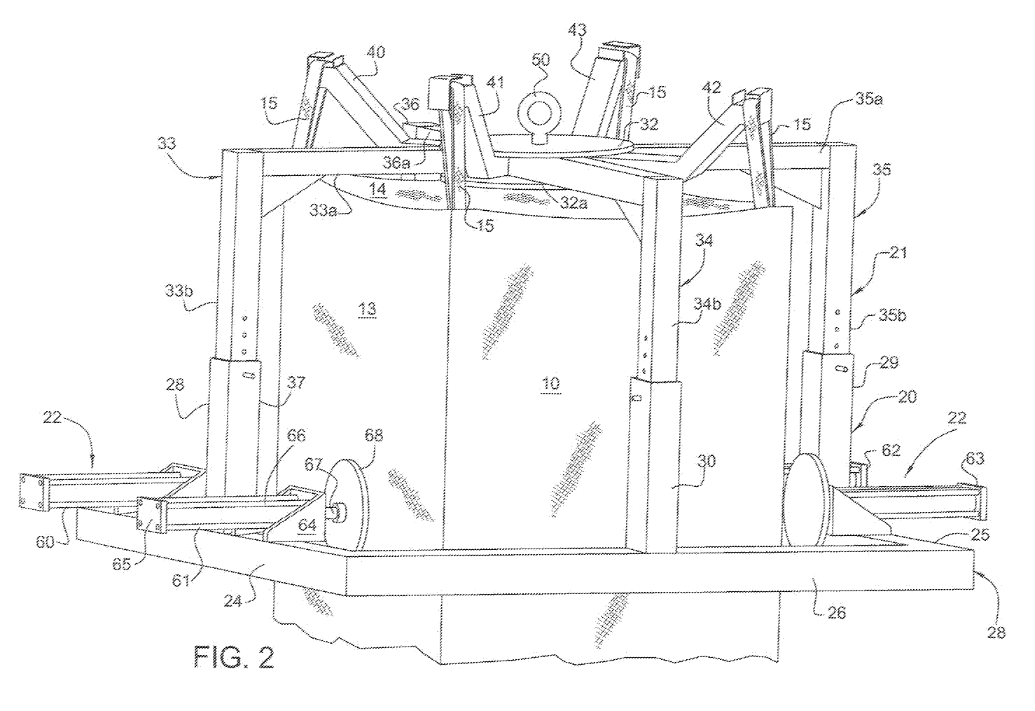

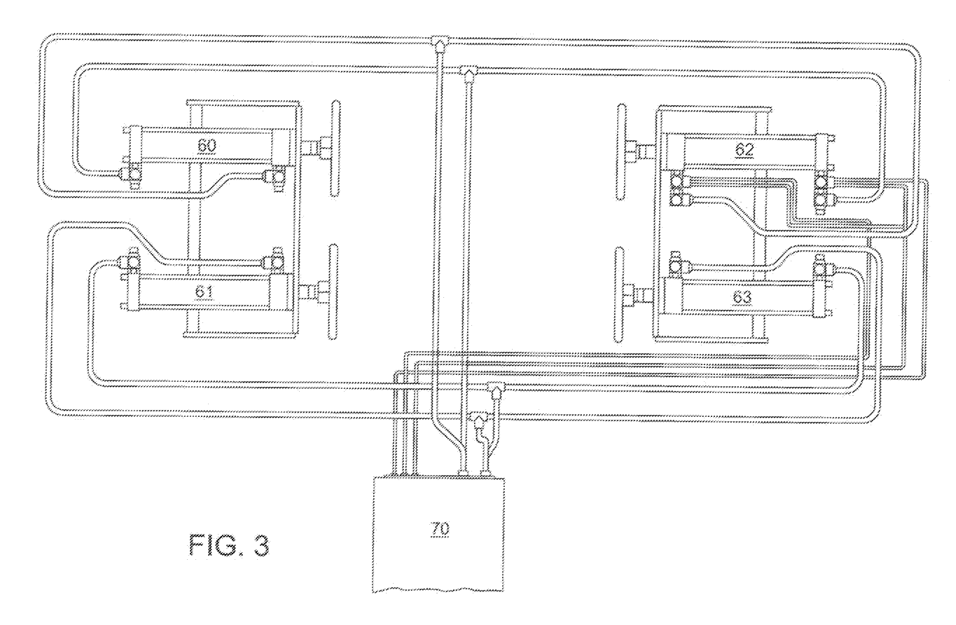

The system for jostling a bag 10 suspended within carrier 11 includes a first pair of cylinder assemblies 60 and 61 mounted on segment 24 of peripheral member 23, and second set of cylinder assemblies 62 and 63 mounted on segment 25 of peripheral member 23 and disposed in alignment with cylinder assemblies 60 and 61, respectively. As best shown in FIG. 2, cylinder assembly 61 is supported on a u-shaped bracket 64 rigidly secured to an upper surface of segment 24, an end plate 65 and a set of elongated rods 66 interconnecting end plate 65 and bracket 64 with cylinder member 67 disposed between such end plate and mounting bracket. The assembly further includes a piston provided with a rod portion 67 having a bag engageable plate 68 mounted on the end thereof. Cylinder assemblies 60, 62 and 63 are similar to cylinder assembly 61, each containing end plates similar to end plate 68 engageable with the sides of a bag suspended within the carrier. In the conventional manner, such cylinder assemblies are provided with fluid under pressure at the opposite ends of the cylinder portions thereof to reciprocate the pistons thereof and further are provided with a control device 70 as shown in FIG. 3 for directing fluid under pressure to the opposite ends of the cylinder members of such assemblies to reciprocate the piston portions thereof and correspondingly cause the plate members to engage and thus jostle the side portions of a bag suspended within the carrier. The reciprocation of the cylinder assemblies may be accomplished using a 4-way, hand operated air valve or a 4-way electrical solenoid-operated valve, either one under the control of an operator. Alternatively, automatic reciprocation of the cylinder assemblies may be accomplished using a purpose-built control system which operates the cylinder assemblies to simultaneously extend to laterally compress the bag and its contents and to retract the cylinder assemblies to allow the bag to resume its normal shape and allow the flow of the bag's contents, out through the discharge spout. In either arrangement, the cylinder assembly. operating force available to apply to the bag is controlled Using an air pressure regulator between the compressed air source and the control system for the cylinder assemblies.

Referring to FIG. 4, receptacle 12 may consist of any type of bin or hopper utilized to store, blend or process a material contained in a bag 10. A single receptacle or multiple numbers of such receptacles may be employed within the scope of the invention. They may be positioned in close proximity as shown in FIG. 4 or at displaced areas. Each of such receptacles, however would be provided with an inlet 80 in an upper wall 81 thereof which is provided with a pan configured structure 82 mounted on upper wall 81, about inlet 80. Preferably, such receptacles would be provided with an access opening 83 permitting an operator to reach into the receptacle and untie or otherwise free a closed spout aligned with or extending through an inlet 80, permitting material within such bag to gravity flow into the receptacle.

Typically, a material to be handled would be deposited in a bag 13 having the opening in the upper wall and the spout in the lower wall closed, resting perhaps on a pallet in a storage, production or other area. When such bag is to be transported to a different site to be emptied, an overhead crane having a carrier 11 suspended from a hoist line as shown in FIG. 4 would be used to align the carrier above and about the confines of the bag, and then lower the carrier to a position as shown in FIG. 2 to permit a workman to attached looped straps 15 to arm members 40 through 43 provided on the upper ends of the carrier. With the bag thus attached to the carrier, the carrier with the bag suspended can be hoisted by the overhead crane, transported to a position above a receptacle 12 and lowered onto a pan 82 with the spout portion of the bag vertically aligned with an inlet 80, possibly partially extending therethrough. In positioning and lowering the carrier with the bag suspended thereon, pan structure 82 aids in centering the lower end of the bag within the confines of the receptacle. With the bag thus postured as shown in FIG. 4, an operator can reach through opening 83 in the side wall of the receptacle to free the spout of the bag and thus permit the gravity flow of material into receptacle 12. Once the spout has been opened to permit the free passage of material from the bag into the receptacle, the jostling system may be activated to cause the plate members of the cylinder assemblies to reciprocate as shown in FIG. 6 to dislodge and impel material within the bag, causing it to gravity flow through the spout into the receptacle. Once the bag has been totally emptied, the overhead crane can be used to lift the carrier and depleted bag and transport them to a site where the bag would be detached from the carrier, permitting the carrier to be used in transporting additional bags filled with material to be transported and emptied. In lieu of an overhead crane being used to position a carrier onto a loaded bag at a site remote from a receptacle into which the bag is to be emptied, a forklift truck can be utilized to lift and transport a loaded bag to be emptied from a remote site to a site adjacent a receptacle 12 where such an overhead crane may be utilized as previously described to position the carrier relative to a loaded bag, permitting such bag to be attached to the carrier, and operating the crane to lift and position the bag on a receptacle as previously described.

The advantage of the invention as described is that it eliminates the cost and possibly the congestion resulting in providing a jostling system on every receptacle into which it is intended to deposit material contained in the type of bag as described. By providing the jostling mechanism only on the carrier of a bag, the expense, encumbrance and operation of a plurality of such systems is avoided.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

We claim:

1. A system comprising:
a receptacle having an inlet for receiving a bulk material therethrough; and
a carrier for supporting a flexible bag with a closable discharge spout, containing a bulk material to be deposited in said receptacle, and means operable upon a hag loaded with bulk material being supported thereon, said spout being aligned with said receptacle inlet and said spout being opened, for jostling said bag to enhance the discharge of said material through said spout into said receptacle;
wherein said carrier and said receptacle are provided with cooperating configurations facilitating the positioning of said carrier relative to said receptacle with said bag spout aligned with said receptacle inlet.

2. The system according to claim 1 including means for transporting said carrier.

3. The system according to claim 2 wherein said transporting means comprises at least one of an overhead crane and a forklift truck.

4. The system according to claim 2 wherein said transporting means comprises an overhead crane provided with a depending line having a hook attachable to a cooperating eyelet on said carrier.

5. The system according to claim 1 wherein said carrier includes means onto which looped straps of said bag may be attached to suspend such bag from said carrier.

6. The system according to claim 1 wherein said jostling means comprises at least one fluid actuated cylinder assembly having a cylinder member rigidly mounted on said carrier and a piston with a contact component on the free end thereof engageable with a bag supported on said carrier.

7. The system according to claim 6 including control means for actuating said cylinder assembly.

8. The system according to claim 6 including at least one pair of fluid actuated cylinder assembles mounted on said carrier on opposed sides of a bag supported on said carrier.

9. The system according to claim 1 wherein said cooperating configurations of said receptacle and said carrier includes a recess in an upper wall of said receptacle having a selected cross-sectional configuration and a lower end of said carrier having a comparable cross-sectional configuration permitting the lower end of a bag carried by said carrier to be positioned within said recess with the spout of said bag to aligned with said receptacle inlet.

10. The system according to claim 1 wherein said receptacle is provided with an access opening suitable to permit an operator to reach into said receptacle when a bag filled with bulk material is positioned above said receptacle with the spout thereof aligned with said receptacle inlet, to open said spout and permit the discharge of material therefrom.

11. A carrier for a flexible bag containing a bulk, comminuted material, having means for being supported on said carrier and a spout at a lower end thereof for discharging said material therefrom, comprising:
a frame having a lower open end and means cooperable with said support means of said bag for mounting said bag on said frame with said lower end of said bag vertically aligned with said lower end of said frame;
means disposed on said frame cooperable with a transporting means for displacing said frame; and
means mounted on said frame having means engageable with a bag supported on said frame for selectively jostling said supported bag to enhance the flow and discharge of material within said bag through the spout thereof.

12. A carrier according to claim 11 wherein said means cooperable with said support means of said bag for mounting said bag on said frame comprise a set of arms of said frame spaced circumferentially relative to a vertical centerline of said frame on which a set of support straps of a bag supported on said frame may be attached.

13. A carrier according to claim 11 wherein said means disposed on said frame cooperable with a transporting means for displacing said frame comprises a member with an opening for receiving a hook of a line of an overhead crane for lifting, lowering and transporting said frame.

14. A carrier according to claim 11 wherein said means for selectively jostling said supported bag comprises at least one fluid actuated cylinder assembly having a cylinder member thereof rigidly mounted on said frame and a piston member having an end portion engageable with said supported bag.

15. A carrier according to claim 14 wherein said piston member includes a plate provided on the free end thereof provided with one of a group including a flat, domed and wedge surface engageable with said bag.

16. A carrier according to claim 14 wherein said cylinder assembly is operatively connectable to a control system functional to selectively reciprocate said piston to agitate material disposed in said bag.

17. A carrier according to claim 14 including at least one pair of said cylinder assemblies, disposed on opposed sides of said frame.

18. A carrier according to claim 14 wherein said frame has a lower end configured to cooperate with a receptacle with an inlet for positioning said carrier with a bag supported thereon relative to said receptacle, to position the spout of said supported bag with said receptacle inlet.

19. A carrier according to claim 11 wherein said frame includes a lower section and an upper section vertically displaceable relative to said lower section for varying, the vertical length of said frame.

20. A carrier according to claim 11 wherein said frame includes a base plate disposed at a vertical centerline thereof, a plurality of arm members circumferentially spaced relative to said centerline, each having a radially disposed section, an angularly displaced section and an end section onto which looped straps of said bag may be attached.

21. A carrier according to claim 20 including an attachment member disposed on said base plate having an eyelet cooperable with a hook of a depending line for lifting, transporting and lowering said carrier.
